(19) United States
(12) Patent Application Publication
(10) Pub. No.: US 2011/0276685 A1
(43) Pub. Date: Nov. 10, 2011

(54) CLOUD COMPUTING AS A SERVICE FOR ENTERPRISE SOFTWARE AND DATA PROVISIONING

(75) Inventors: Abraham Benjamin de Waal, San Jose, CA (US); Niels Joubert, Los Altos, CA (US); Stephanus Jansen DeSwardt, Los Altos, CA (US); Pieter Hendrik Joubert, Los Altos, CA (US)

(73) Assignee: BRUTESOFT, INC., LOS ALTOS, CA (US)

(21) Appl. No.: 13/103,265

(22) Filed: May 9, 2011

Related U.S. Application Data
(63) Continuation-in-part of application No. 13/012,584, filed on Jan. 24, 2011.
(60) Provisional application No. 61/297,390, filed on Jan. 22, 2010.

(51) Int. Cl. G06F 15/173

(52) U.S. Cl. 709/224

(57) ABSTRACT

A system, including a central server, remotely install server agents, and administrative agents, is disclosed for provisioning software and updates, maintenance directives, and data to client machines within a central domain or a remote disjoint domain. By monitoring network traffic through various network nodes, a focal point of network traffic for all machines in the domain may be identified by the central server. A server agent is installed at the focal point network node for identifying all machines in the domain. Administrative agents are installed on all identified machines. The administrative agents facilitate the copying and distribution of files needed for software and data provisioning and maintenance.

### CROSS-REFERENCE TO RELATED PATENT DOCUMENTS

This patent application claims a priority benefit to and is a continuation-in-part of U.S. patent application Ser. No. 13/012,584, filed on Jan. 24, 2011, and entitled “APPLYING CLOUD COMPUTING AS A SERVICE FOR ENTERPRISE SOFTWARE AND DATA PROVISIONING” (Attorney Docket No. 3034.003US1), which claims the priority benefit of U.S. Provisional Application No. 61/297,390, filed Jan. 22, 2010, and titled “APPLYING CLOUD COMPUTING AS A SERVICE FOR ENTERPRISE SOFTWARE AND DATA PROVISIONING” (Attorney Docket No. 3034.003PRV), both of which are incorporated herein by reference in their entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright 2011, BRUTESOFT, INC. All Rights Reserved.

### TECHNICAL FIELD

This patent document pertains generally to data processing, and more particularly, but not by way of limitation, to applying cloud computing as a service for enterprise software and data provisioning.

### BACKGROUND

Provisioning computers with software, whether the software is an update, a patch, updated virus definitions, or a new install, means moving data to a machine and executing a set of instructions to make this software available to the end-user. End-users do this for their personal computers by downloading or using physical media to acquire the software package, and manually click through instructions to install it. Enterprises face the challenge of keeping their computers updated with the latest software and licenses required by their employees and keeping their computers secure by applying patches in a timely fashion. Expecting employees to be responsible for manually following policies is unreasonable, especially in the face of time-sensitive security updates and virus definitions, and requiring an information technology (IT) team to follow the same manual practices as end-users to maintain computers does not scale beyond very small businesses.

The software industry has responded by creating management tools for enforcing software policies and performing remote, unattended software installs. These tools allow system administrators to configure the software ecosystem of computers, and aid package movement and installation. Traditional software delivery inside the enterprise uses a central repository on a dedicated server that publishes software packages to the network. Clients, upon receiving instructions to install a certain package, connect to this central server to download the necessary package.

Software management tools have approached this problem with several attempts to provide scaling without expensive infrastructure requirements. Internet protocol (IP) Multicast technology allows a single stream of packets to reach many client machines, with scaling supplied by the Network Layer of the infrastructure rather than the end-point servers. Multicast, when available, requires that all receiving machines coordinate perfectly, correctly receive each packet with no interruptions or failures. As the number of clients increase, failures inevitably occur—both as network load causes packet loss and users interact with computers while software distribution occurs. This prevents system administrators from doing on-demand software distribution or operating during business hours. This approach also does not scale to devices that experience large fluctuations in network quality and availability such as laptops and mobile devices.

Some of the problems facing network administrators in large enterprises include how to discover client machines in need of information technology (IT) maintenance and software (SW) installations, how to centrally manage the deployment and installation of software and updates, and how to manage machines which are not able to be remotely administrated.

Another challenge being faced by enterprises is how to detect intermittently connected client machines. Many businesses today, including large retail chain stores, do not have client machines at all retail sites in continuous communication with a central host or computer system. Some of the client machines may be laptops that are inherently mobile and easily disconnected from the store network. This presents a significant challenge to IT systems and managers to know what machines are on the network at any given time and are in need of being included in a given deployment of software or a particular cycle of maintenance.

Classically, all machines in an enterprise network would be documented manually by IT system personnel. The documentation process would determine the type and location of all the machines in the network. A catalog or registry of all machines would be created at the end of the documentation process. If a particular machine is not connected at the time that the manual documentation process was conducted, that machine would not be known in the catalog and quite possibly not be updated with software requirements or maintained at the proper schedule.

A fallback position for IT administrators has been to send an e-mail to all users of client machines and request that each user follow prescribed instructions for system maintenance and software installation. Other approaches for addressing non-remotely administrable machines have included direct contact of users by IT personnel or having IT staff physically attend to that machine. None of these approaches are satisfactory for ongoing IT support in a large enterprise. This procedure does not guarantee that all machines will be uniformly administered. In the case of e-mail to each client machine, the actual time of implementation of the instructions, let alone the correctness of installation and maintenance, are the responsibility of each individual user. In some cases, it is possible for a given client machine to be several generations behind in software and maintenance releases if the user does not follow the IT administrator's instructions promptly.

### BRIEF DESCRIPTION OF DRAWINGS

Some embodiments are illustrated by way of example and not limitation in the figures of the accompanying drawings in which:

FIG. 1 is a system diagram of a networking environment able to provision software and data through installed agents, according to an example embodiment;

FIG. 2 is a block diagram representation of central server architecture able to detect client machines associated with network focal points, according to an example embodiment;

FIG. 3 is a topological diagram of a network addressing scheme used in topological analysis, as used in an example embodiment;

FIG. 4 is a block diagram of a networking system with installed agents for copying files in software and data provisioning, as used in an example embodiment;

FIG. 5 is a flowchart diagramming the process of identifying machines and installing administrative agents, according to an example embodiment;

FIGS. 6A and 6B are a flow chart diagramming the process of configuring a service registry to support software and data provisioning, according to an example embodiment;

FIGS. 7A and 7B are a flow chart diagramming the process of provisioning software and data in a disjoint network with installed agents, according to an example embodiment;

FIG. 8 is a flowchart diagramming a method of identifying and classifying client machines in a local network domain, as used in an example embodiment;

FIG. 9 is a flowchart diagramming a method of identifying and classifying client machines in a disjoint network domain, as used in an example embodiment;

FIG. 10 is a block diagram of machine in the example form of a computer system within which a set instructions, for causing the machine to perform any one or more of the methodologies discussed herein, may be executed.

### DETAILED DESCRIPTION

In the following description, for purposes of explanation, numerous specific details are set forth in order to provide a thorough understanding of some example embodiments. It will be evident, however, to one skilled in the art that the present invention may be practiced without these specific details.

### Environment

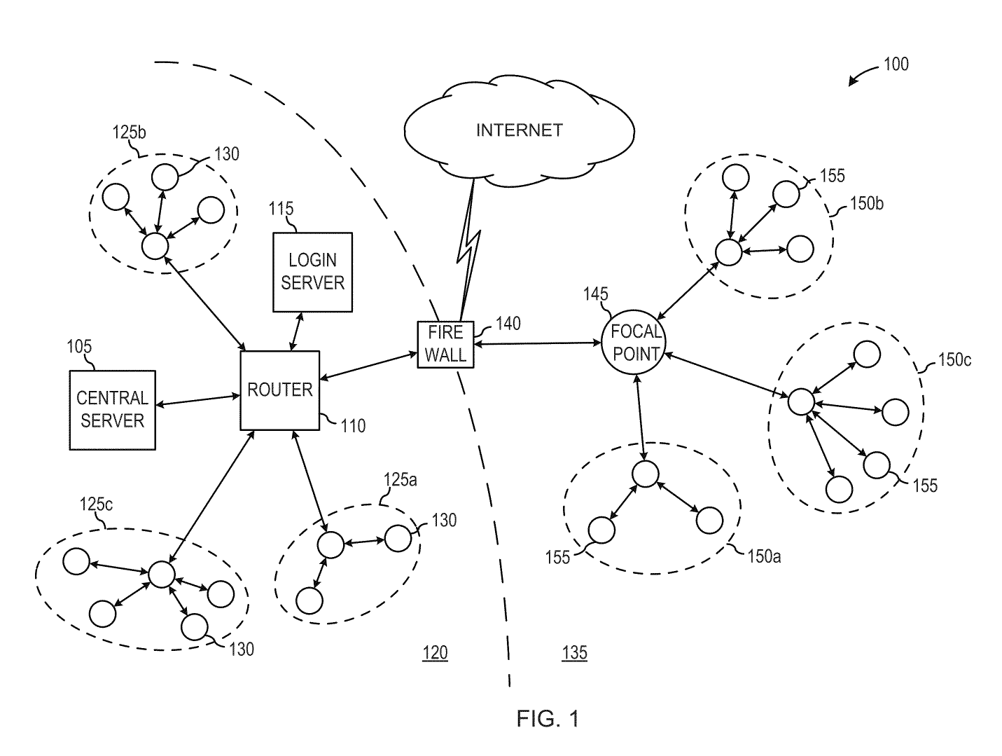

FIG. 1 depicts an example system for software and data provisioning 100 that includes network resources in the form of a central server 105, a router 110, and a login server 115 located within a central enterprise domain 120. The network resources are communicatively coupled with one another through a network. The central enterprise domain 120 also includes a series of client machine clusters 125a-c, each including a collection of client machines 130. Any one of the network resources or client machines 130 may be communicatively coupled with a disjoint domain 135 through a firewall 140 situated at a boundary between the central enterprise domain 120 and the disjoint domain 135. The firewall 140 may be communicatively coupled with any of the network resources or client machines 130 to the Internet or an external network node 145 which may be operating as a focal point of network traffic. The external network node 145 may in turn be electrically coupled to a series of external client machine clusters 150a-c each including a collection of external client machines 155.

Enterprises often exist in multiple physical locations, with the enterprise network topology typically reflecting this physical layout. Wide area network (WAN) backbone links between offices, and local area networks (LANs) connecting machines 130 and external machines 155 within an office, typically correspond closely to the physical layout of the enterprise. WAN connections are expectedly lower-bandwidth than the total bandwidth available inside an office, so to avoid having all clients connect to a central repository for software downloads, distribution servers are placed in branch offices to mirror the central software repository. The infrastructure requirements for software provisioning thus demands maintaining both a pool of central servers and possibly having distribution servers in branch offices. As the amount of clients in an enterprise increases, so do the requirements of the software distribution infrastructure and the associated costs of purchasing, maintaining, housing, and powering these servers.

A more ideal situation in enterprise administration would be to have all of the machines 130 and external machines 155 enabled for remote management (e.g., able to be remotely configured and remotely administered). IT administrators prefer to control provisioning as each machine 130 is deployed so that an initial configuration includes settings for remote administration. Once remote administration is enabled, IT administrators may provide the installation of software upgrades and system maintenance from a single, central location with high degrees of automation, which may include, using purpose-built administration tools and custom tailored scripts.

The use of centrally located administration tools is ideal when an enterprise has a unified domain, i.e. a domain that does not have an association with additional disjoint or sporadically coupled domains. When some domains of an enterprise lie outside of the firewall of a central domain, a more ideal solution is to have an administrative agent installed on each machine 130 or remote machine 155 that may be configured to initiate maintenance related communications with the central server 105. In this way, the administrative agent may take care of communicating with a central server 105 to gain instructions for installing software updates, initiating maintenance, and reporting client status. Note, that the terms “communication” or “communications” are equivalent to “network traffic.”

An additional benefit of having an administrative agent on each client machine 130 or remote machine 155 is that administration related communication with the central server 105 that is initiated by the administrative agent avoids the challenges of having a central server 105 initiating communications from outside of a firewall that may be protecting a domain where the client machine 130 or remote machine 155 resides. In the firewall protected situation, each communication initiated by the central server 105 may be challenged by the firewall and protective filtering for the domain where target client machines 130 and external machines 155 reside. Having an autonomous administrative agent that communicates with the central server 105 and maintains a schedule of software upgrades and maintenance may be the ultimate IT management situation for a large enterprise of disparate domain types.

A main challenge facing deployment of an administrative agent on each machine 130 or remote machine 155 of an enterprise is how to classify each machine 130 or remote machine 155 and maintain a service registry of deployed administrative agents. Yet, most fundamental is the challenge of the initial discovery of all client machines 130 and external machines 155 in the domain that need to be administered. Once discovered, each machine 130 or remote machine 155 must be classified in a centralized registry and provided with an administrative agent configured appropriately for each respective machine configuration. An additional challenge is that certain newly discovered client machines 130 and external machines 155, especially in remote domains such as the disjoint domain 135, for example, may not be communicatively coupled with the central server 105 at the time discovery operations are performed.

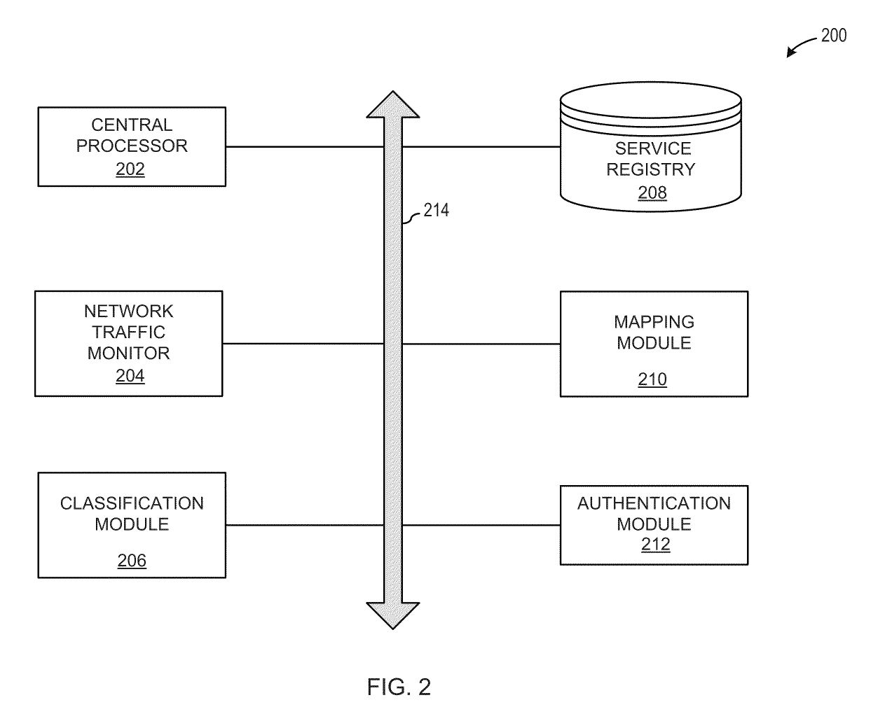

FIG. 2 depicts an example central server architecture 200 implemented with the inclusion of a central processor 202 and central communication bus 214. The central system architecture 200 may also include a network traffic monitor 204, a classification module 206, a mapping module 210, and an authentication module 212. Additionally, a service registry 208 may be communicatively coupled with the central communication bus 214. Each of the central processor 202, the network traffic monitor 204, the classification module 206, the mapping module 210, and the authentication module 212 may be electrically coupled with one another as well as with the service registry 208 through the central communication bus 214.

The network traffic monitor 204 may work independently or in conjunction with a remote network node such as the external network node 145 to detect a focal point of network traffic and report monitoring results to the central server 105. The classification module 206 may work in conjunction with the central processor 202 to classify machines 130 and external machines 155 in the service registry 208 according to identifier information received in the monitoring process. The mapping module 210 may also work in conjunction with the central processor 202 to map the registered entry of each machine 130 or remote machine 155 to a corresponding service classification. The authentication module 212 may work in conjunction with the central processor 202 in an authenticating process involved with non-remotely administrable machines 130 and external machines 155 (discussed below).

By way of example, any of the network traffic monitor 204, the classification module 206, the mapping module 210, or the authentication module 212 may be implemented either as a hardware module or a software module, or a combination thereof. For instance, anyone of these modules may be implementable as a software module and maybe executed either on the central processor 202, a remote server, or any network node capable of software execution. Furthermore, any of these modules which may be implemented as a software module may be implemented in any of a number of programming languages or instruction sets that may, in any combination, be compiled, assembled, linker-loaded, or interpreted so as to be executed on any of a number of hardware platforms capable of executing those instructions to effect the behavior of the methods as described herein.

The discovery of every client machine 130 or remote machine 155 in need of software and data provisioning may be achieved by monitoring network traffic initiated by each respective machine 130 or remote machine 155 with network resources such as the central server 105, the router 110, or the login server 115. One approach to solving the challenge of client machine 130 or remote machine 155 discovery is for the central server 105 to identify a network node that operates as a focal point of network traffic and which may additionally be associated with each client machine 130 or remote machine 155 in a network domain. The network traffic monitor 204 may be instructed by the central processor 202 to monitor network traffic both within the central enterprise domain 120 as well as the disjoint domain 135, for example.

Note that the term “machine” and “client machines” may be used equivalently and interchangeably throughout the following description to represent either the client machines 130 or the external client machines 155, as context may indicate, especially in regard to any context-specific affiliation to either the central server 105 or the external network node 145, for example. Also note that network traffic and network communications may refer equivalently and interchangeably to bidirectional or unidirectional communications initiated with electromagnetic signaling over a network or enterprise network. Network load may refer to the amount of network traffic and network quality may refer to the quality and integrity of communications over a network.

To be a focal point, the network node may be a point in the network where a high percentage, if not all, of the users and their machines 130 and external machines 155 may eventually use to propagate network communications through. The focal point may be a network node within the central enterprise domain 120 or may be located as a gateway to communications external to the enterprise. A focal point of network traffic may be the firewall 140, the router 110, an allocator of dynamic IP addresses (not shown), a Dynamic Host Configuration Protocol (DHCP) server (not shown), a domain name server (not shown), or any existing filtering network node (not shown). Additionally, as will be further discussed below, a focal point may be located external to the central enterprise domain 120 or located on a server that operates autonomously with the same capabilities as the central server 105.

Identifying each machine 130 or remote machine 155 (or equivalently “client machine” or “remote client machine”) may involve monitoring network traffic propagating through the identified focal point network node. Identifier information is collected for each client machine 130 or remote machine 155 that initiates network traffic through the focal point network node to a network resource. A network resource may be, for example, a webpage server, the login server 115, a print server, or an online search engine. A portion of network traffic corresponding to a particular machine 130 or remote machine 155 that is able to be monitored may include access to a webpage, logging in to a machine 130 or remote machine 155, or logging into an online account by a user of the client machine 130 or remote machine 155.

The central server 105 may distribute a server agent to the network node determined to be the focal point of network traffic. The server agent may monitor network traffic through the focal point network node and transmit results of the monitoring back to the central server 105. The server agent may gather identifier information corresponding to each client machine 130 or remote machine 155 as a connection is made with a network resource. The server agent may transmit the monitored information to the central server 105. For instance, the results of a user logging in to an online account or interacting with a target webpage may be detected by the server agent and reported back to the central server 105. For Internet browser related network traffic, the target of the browsing activity is not critical. The server agent may also transmit an indication of the user's machine 130 or remote machine 155 interacting with these nonspecific network resources back to the central server 105.

Monitored information for each machine 130 or remote machine 155 may include at least one of an identifier, a configuration listing, a network address, a machine name, a user identifier, or an administrable state. Besides fundamental identifier information, the configuration listing may include a list of hardware resources contained in the machines 130 and external machines 155 as well as a list of software modules configured on the machine 130 or remote machine 155 which may be subject to maintenance and updates. The administrable state is typically an indication of whether the machine 130 or remote machine 155 is remotely administrable or not.

The central server 105 may store the received identifier information for each machine in the service registry 208. The identifier information may be stored in a data structure within the service registry 208. One example embodiment of a network address may be internet protocol (IP) network address. The network addresses of various identified machines 130 and external machines 155 may be stored in an IP address table, for example. As the identifier information is stored or at any time after initial storage, information may be classified using a decision tree. The decision tree may include processes for matching the network address to a topological location, determining a backup schedule and backup policies corresponding to characteristics of the identifier information, and assigning a management profile corresponding to the determined backup schedule and backup policies of each respective machine 130 or remote machine 155.

Additionally, the central server 105 may determine from the identifier information from each respective machine 130 or remote machine 155, whether any software versions or maintenance directives are missing from the configuration listing, whether the machine 130 or remote machine 155 is newly discovered, as well as whether the machine 130 or remote machine 155 may be remotely administered. The central server 105 may map each machine 130 or remote machine 155 within the service registry to a service classification. The service classification may include indicators of the machine's 130 or remote machine 155 being remotely administrable, newly discovered, yet to be administered by a software upgrade or maintenance routine, and whether any software or general machine directives are missing from the configuration listing of the machine 130 or remote machine 155. From the service classification, a general management profile may be configured to support ongoing software upgrades and maintenance processes for each respective machine 130 or remote machine 155. The service registry may contain all identifier information, the service classification, including ongoing updates to the various indicators, and the configured maintenance profile for each respective machine 130 or remote machine 155.

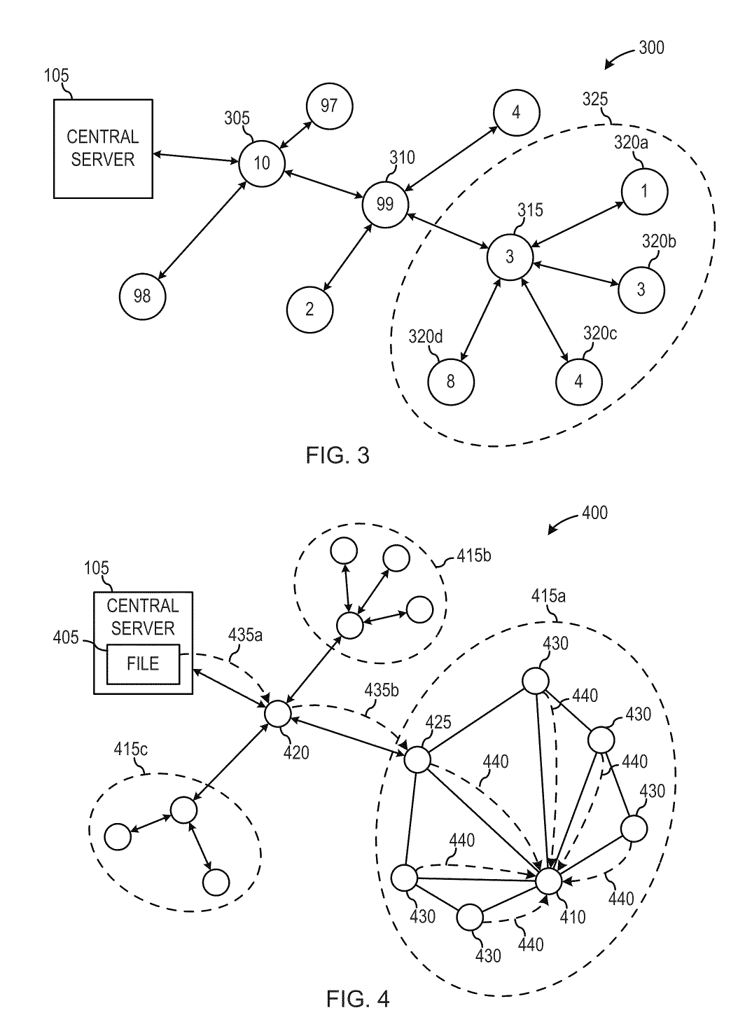

FIG. 3 depicts an example IP network topological analysis diagram 300. Within the identifier information stored in the service registry 208, the central server 105 may analyze the network address of each machine 130 or remote machine 155. IP addresses may be analyzed to determine certain aspects of the installation topology of geographically related machines 130 and external machines 155. The network address may typically include subnet fields. In Internet protocol version 4 (IPv4) addresses are canonically represented in dotted-decimal notation which consists of four decimal numbers each ranging from 0 to 255, separated by dots, e.g., “10.99.3.1”.¹ The evolution of various IP address space conventions used in defining network identifier (ID), host ID, and private network formats notwithstanding, for the purposes of this example the four decimal numbers will be referred to as subnet fields or simply subnets. The central server 105 may analyze the subnet fields of an IP address to determine the topological location of the machine 130 or remote machine 155. IP addresses are not only unique addresses to follow in a subnet addressing sequence, but the addresses may also indicate relatively localized geographical affiliations of machines 130 and external machines 155 which generally map to near-valued addresses. This characteristic is typically an artifact of the initial network set up by IT staff. Sub network fields may determine segregation in an enterprise between rooms or floors of a building, between buildings, or between campuses. ¹ See Wikipedia, IP address @ en.wikipedia.org/wiki/IP_address.

Further analysis of the identifier information for several machines may reveal that a particular value or address within a subnet field may map to a local network topology associated with a collection of geographically related machines. For example, in the instance where an IP network address is 10.99.3.4 320c for a given machine in a laboratory 325, analysis of monitored identifier information by the central server 105 may determine that additional machines 320a-d having IP network addresses of the form 10.99.3.xx are also located in the same laboratory 325. The central server 105 may be electrically coupled to a first-level host machine 305 serving network addresses in the range 10.9x.xx.xx, which in turn serves a second-level host machine 310 serving network addresses in the range of 10.99.0x.xx, which in turn serves a third-level host machine 315 serving network addresses in the range of 10.99.3.x. The third-level host machine 315 may in turn serve co-located machines 320a-d which may each be located in a laboratory 325. The central server 105 may further configure the service registry 208 to accommodate the machines 320a-d associated by the local topology (i.e., the laboratory 325) and use this information in configuring the management profile and updating settings in the service classification.

From the identifier information stored in the service registry 208, the central server 105 may determine which machines are capable of being remotely administrable. From the perspective of the central server 105, any machine 130,155 that is remotely administrable may, in theory, have direct provisioning of software, maintenance, and data. Yet this approach for the continual provisioning of machines 130 and external machines 155 (even though a particular machine 130 or external machine 155 is remotely administrable) is not optimal. Enterprise networks may include security features that may inhibit the ability of the central server 105 to readily access client machines 130 and external machines 155 as may be needed for the ongoing provisioning of software and data. Since firewalls and certain security mechanisms may exist in the enterprise network, it is important that the communications be initiated from the client machine 130 or remote machine 155. An entity, such as the central server 105, outside the domain of the client machine 130 or remote machine 155 (e.g., across the firewall/security mechanism boundary) is not able to penetrate into the client machine 130 or remote machine 155 and affect configuration changes or software implementation with a required level of assurance. Certain security filtering may mean that the same situation effectively exists even for intra-domain provisioning communications. It may be possible for a machine 130 or remote machine 155 to have a local firewall installed even though the machine 130 or remote machine 155 may sit within a particular enterprise domain.

As mentioned above, one method of initiating communications to the central server 105 from the client machine 130 or remote machine 155 is by using an agent (or administrative agent) that resides on the client machine 130 or remote machine 155. For any remotely administrable machine 130 or remote machine 155, the central server 105 may take charge of the initial copying, installation, and initiation of the agent from a server-side perspective. Either at the initial installation of the agent by the central server 105 or by the functions of the installed agent, the remotely administrable machine 130 or remote machine 155 may have all necessary machine characteristics set such that ongoing provisioning of software and data are possible with the agent's initiation.

The agent may effectively operate as a server and for instance, manage all data files received from the central server 105 or central data center. In a capacity like that of a server, the agent may perform execution of the installation of data files. Installation may be performed without any user intervention (or awareness) whatsoever. The agent may use Microsoft standard (.msi) installation files and the Microsoft (MS) installer. Software that is not “.msi compliant” may have a script provided by the data center and retained in the agent for use when appropriate. This server approach to the agent behavior may maintain a homogenous setup for data installation uniformity across the enterprise.

When the administrable state of a further machine 130 or remote machine 155 is determined to not be remotely administrable, access by the machine 130 or remote machine 155 to a targeted webpage, for example, maybe redirected to an administrative webpage. The redirection of the webpage may be initiated with special code put in place by the central server 105. At the administrative webpage, an authenticating process may be provided by the central server 105 regarding a set of administrative instructions to be carried out by the user of the machine 130 or remote machine 155. The authenticating process is for gaining the confidence of the user and for certifying the correctness and legitimacy of the administrative instructions that are expected to be carried out by the user. In response to providing the authenticated set of administrative instructions and the user carrying out the instructions, the central server 105 may receive permission from the user to copy, install, and initialize an agent on the further machine 130 or remote machine 155.

From a user's perspective, for example, implementation of this redirection process may appear as a situation where a user arriving at their machine 130 or remote machine 155 expects to commence their day's work and perhaps begin by logging in to their machine 130 or remote machine 155 or to commence browsing the Internet. Instead of completing the login process or receiving the expected Internet webpage, a special webpage initiated by the central server 105 and produced by the IT administration may appear on the machine 130 or remote machine 155 with a message directed to the user, assuring them of the authenticity of the installation instructions to follow. Redirection only occurs when necessary to secure ongoing provisioning of the client machine 130 or remote machine 155 and only occurs when a connection to the central server 105 is available. Redirection is not necessary if machine 130 or remote machine 155 is already configured or already has the agent and redirection may be avoided when these conditions are detected. The central server 105 keeps records in a database of which detected machines 130 and external machines 155 are in need of reconfiguration, installation of the agent, and receipt of the redirecting webpage. Alternatively, a process may be initiated by the central server 105, such as a log-back process to a known authentic website for network administration, to receive instructions for allowing installation of the agent.

Once installed, the agent may be responsible for initiating communication to the central server 105 for receiving software updates, maintenance processes, or data, for example. As a first step, prior to commencing any update and maintenance processes, the agent may review the machine 130 or remote machine 155 on which it is installed to fully determine all of the identifier information associated with the machine 130 or remote machine 155. The identifier information may be the same as that collected by the server agent as discussed above. The agent may have access to further aspects of the identifier information or to changes in the identifier information compared to that available to the server agent in the initial identification and detection process by the server agent described above. Once a complete set of identifier information is determined, the agent may initiate communication with the central server 105 and report the identifier information to the central server 105 for storage, classification, and configuration in the service registry 208.

In general, the agent may also be responsible for the ongoing processing of maintenance and servicing instructions received from the central server 105 at some previous connection with the central server 105. In this way, it is not required that the agent, nor for that matter the client machine 130 or remote machine 155 itself, to be in continuous communication with—or connection to the central server 105. The agent may regularly perform reconnaissance on the associated client machine 130 or remote machine 155 to determine whether any further software has been installed by the user, whether any maintenance processes are in need of being performed, and whether the configuration, such as the hardware configuration of the machine 130 or remote machine 155 itself has changed since the last classification was made with the service registry 208. The agent may initiate communication with either the central server 105 or an additional central repository of software versions or reference of software versioning information to determine whether the machine 130 or remote machine 155 has up to date software and/or software suitable to the present configuration. The same sort of checking and assurance processes may be performed by the agent with regard to service and maintenance directives pertaining to the client machine 130 or remote machine 155.

From an architectural perspective, the agent may contain an execution module and the configuration module (not shown). The execution module contains a general set of instructions to be carried out by the agent in performing the general processes of updating and maintaining software and data on the client machine 130 or remote machine 155. The configuration module may contain a peculiar set of features or characteristics of the provisioning process to be carried out by the agent that pertain to the present enterprise and the particular machine 130 or remote machine 155 under consideration.

FIG. 4 is an example system maintenance topology used in file copying 400. The central server 105 may contain a file 405 intended for copying to a target machine 410 within a first cluster of machines 415a. The central server 105 may be electrically coupled with several clusters of machines 415a-c through a common network node 420 such as a router or a further server, for example. The common network node 420 may be electrically coupled to a primary machine 425 in the first cluster of machines 415a. A primary machine 425 may be directly coupled with several secondary machines 430 and the target machine 410 (note that not all direct connections in the first cluster of machines 415a are shown).

The file 405 may be a new version of a software release, a set of maintenance instructions, or data that is generally intended for any of the machines in any of the clusters of machines 415a-c. The central server 105 may have previously installed an agent (not shown) on each of the primary machine 425, the target machine 410, and the secondary machines 430 to assist in a range of maintenance operations such as copying the file 405. An initial copying of the file 405 may have occurred with a primary transmission 435a from the central server 105 to the common network node 420 where the file may be available for copying to each of the clusters of machines 415a-c. With a secondary transmission 435b from the common network node 420 to the primary machine 425, the file 405 may be made available to each machine in the first cluster of machines 415a.

Through various receiving and copying operations within each agent, all or portions of the file 405 may be distributed to the secondary machines 430. The entirety of the file 405 may be supplied through several aggregating transmissions 440 of the various portions of the file 405 from the primary machine 425 and the secondary machines 430 to the target machine 410. Each of the aggregating transmissions 440 may copy only a portion of the file 405, but orchestration by the installed agents in the primary machine 425 and the secondary machines 430 make sure that the entire file 405 is copied to the target machine 410.

Cumulatively, the aggregating transmissions 440 may provide a significantly higher total bandwidth for copying the file 405 to the target machine 410 than would be available in a straight through transmission of the file 405 from the central server 105 through the common network node 420 to the primary machine 425 with the primary transmission 435a, the secondary transmission 435b, and a final copying transmission from the primary machine 425 to the target machine 410. The bandwidth of the connections from the central server 105, through the common network node 420, and to the primary machine 425, are typically and often necessarily less than the cumulative bandwidth of the aggregating transmissions 440. In this way, a collection of installed agents on secondary machines 430 may provide software and maintenance updates to the target machine 410 or any newly installed machine within the first cluster of machines 415a and do so more quickly than would a single inline transmission from the central server 105.

This peer-to-peer copying process is likewise available, for example, in the additional clusters of machines 415b,c. This process also avoids the possibility of saturating the single in-line transmission bandwidth from the central server 105 to several target machines within the clusters of machines 415a-c that may be requested in parallel and nearly simultaneously for a given maintenance update. The peer-to-peer copying process produced by the installed agents described above, may be exercised at any time including common workplace hours without disruption of network traffic due to typical workplace activities. Additionally, the problem of the Multicast distribution of files and the requirement of perfect coordination of the receipt of each packet with no interruptions or failures on the part of each receiving machine is avoided by having each installed agent able to manage the sharing of installation information and appropriate portions of the target files with other agents.

### Servicing Remote Domains

The central server 105 may reside in the central enterprise domain 120 and be in communication with additional servers and client machines 130 and external machines 155 in any number of remote domains as represented by the disjoint domain 135 (FIG. 1). Through contact with the external network node 145 in the disjoint domain 135, the central server 105 may determine that the external network node 145 is a likely focal point of network traffic for the disjoint domain 135. The central server 105 may initiate similar network traffic monitoring processes to those discussed above by facilitating the external network node 145 with a server agent to initiate monitoring of further network traffic propagating through the focal point which is associated with access to further network resources by the external client machines 155. The central server 105 may commence initial network traffic monitoring processes by having the external network node 145 and several additional focal point candidates transmit to the central server 105 an accounting of the network traffic flowing through the respective candidate focal point nodes. The central server 105 may identify the focal point nature of the external network node 145 and select the external network node 145 to monitor the further network traffic in the disjoint domain 135. The external machines 155 in the disjoint domain 135 may have initiated further network traffic to further network resources within the disjoint network domain or some other domain external to the disjoint domain 135.

The central server 105 may facilitate further monitoring of network traffic in the disjoint domain 135 by installing a remote server agent (not shown) on the external network node 145 during an initial period of connectivity. During a subsequent period of connectivity, the central server 105 may receive cached identifier information from the remote server agent where the identifier information corresponds to each monitored external machine 155 of the disjoint domain 135. This identifier information, in a process similar to that discussed above in regard to the focal point in the central domain, may become available as the external machines 155 have access to further network resources or network resources in the central enterprise domain 120. The remote server agent may store the identifier information in a cache until a subsequent connection to the central server 105 is established.

Alternatively, the remote server agent may also establish locally, in combination with the local cache, a remote service registry (not shown) with all of the capabilities described above in regard to the centrally located service registry 208. This remote service registry may contain all of the identifier information corresponding to the further detected external machines 155 identified from the remote monitoring processes. The remote service registry may contain identifier information, data structures, address tables, service classifications, and management profiles and may also be configured in a manner similar to that for the service registry 208 associated with the central server 105 as discussed above. The remote server agent is capable of operating autonomously from the central server 105 and may carry out all of the features and services as those performed by the combination of the central server 105 and the server agent as described above in relation to the central enterprise domain 120.

In operation, the remote server agent receives instructions from, for example, the central server 105 that allow the remote server agent to operate autonomously from the central server 105 and carry out the central server 105 instructions until a further connection with the central server 105 is established in a subsequent period of connectivity. The central server 105 instructions may also have the remote server agent connect to the central server 105 when a certain set of conditions are present or whenever possible. The remote server agent may also receive instructions from a central data center (not shown) or similar centralized facility as may be typical in certain enterprise configurations.

By way of example, instructions from the central server 105 may require the remote server agent to monitor network traffic propagating through the focal point in the external network node 145. Additionally, the instructions may include commands to the external network node 145 to populate the remote service registry with identifier information, including the administrable state, corresponding to each external machine 155 being monitored. The instructions may also include directives to install an agent on each further external machine 155 where the identifier information indicates the machine 155 is remotely administrable. The remote server agent may also be instructed to store identifier information as well as the results generated by the respective agents in a cache maintained locally in the external network node 145.

The instructions from the central server 105 may typically instruct the remote server agent to gather identifier information and results from installed agents for a period of time extending from an initial period of connectivity with the central server 105 through a subsequent period of connectivity with the central server 105. When the subsequent period of connectivity is established, the remote server agent may push cached information to—and pull further instructions from the central server 105. The remote server agent may typically contain the entire connectivity information for the disjoint domain 135 that it resides in and may or may not contain the entire connectivity information for the remainder of the enterprise domains. When the remote server agent contains only connectivity information for the disjoint domain 135, certain of the network addresses, corresponding to other portions of the enterprise network, may be reused within the disjoint sub-network.

The remote server agent may also receive instructions from a central server 105 regarding a further external machine 155, with an administrable state determined to not be remotely administrable, to redirect access of the further external machine 155 from a targeted webpage to an administrative webpage. In a fashion similar to that described above in regard to the server agent, the remote server agent may also be instructed to provide or produce the administrative webpage, including an authenticating process regarding a set of administrative instructions to be carried out by a user at the further external machine 155. In response to providing the authenticating process, the remote server agent may receive permission from the user to copy, install, and initialize an agent on the further external client machine 155. As with the remote machine 155 described above, the results from the agent installed on the further remote machine 155, and any corresponding identifier information obtained during monitoring by the remote server agent, is cached during a period of time extending from the initial period of connectivity through the subsequent period of connectivity with the central server 105.

### Methods

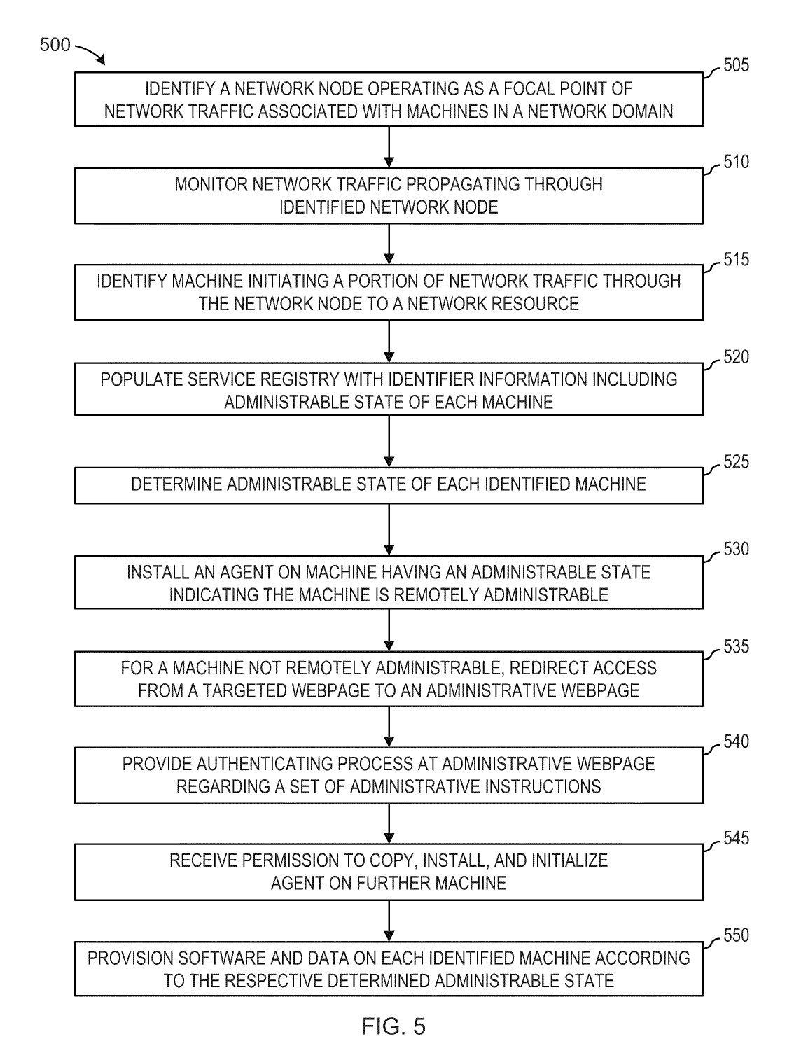

FIG. 5 depicts an example method of provisioning software and data 500 by identifying client machines and installing an administrative agent according to the administrable state of each machine. The method commences with identifying 505 a network node that operates as a focal point of network traffic associated with machines in a network domain and monitoring 510 the network traffic propagating through the identified network node. The method continues by identifying 515 a machine initiating a portion of the network traffic through the network node to a network resource and populating 520 a service registry with identifier information that includes the administrable state of each machine. The method goes on with determining 525 the administrable state of each identified machine and installing 530 an agent on each machine having an administrable state indicating that the machine is remotely administrable. For a machine not remotely administrable the method continues with redirecting 535 access from a targeted webpage to an administrative webpage and providing 540 an authenticating process at the administrative webpage regarding a set of administrative instructions. The method concludes with receiving 545 permission to copy, install, and initialize an agent on the further machine and provisioning 550 software and data on each identified machine according to the respective determined administrable state.

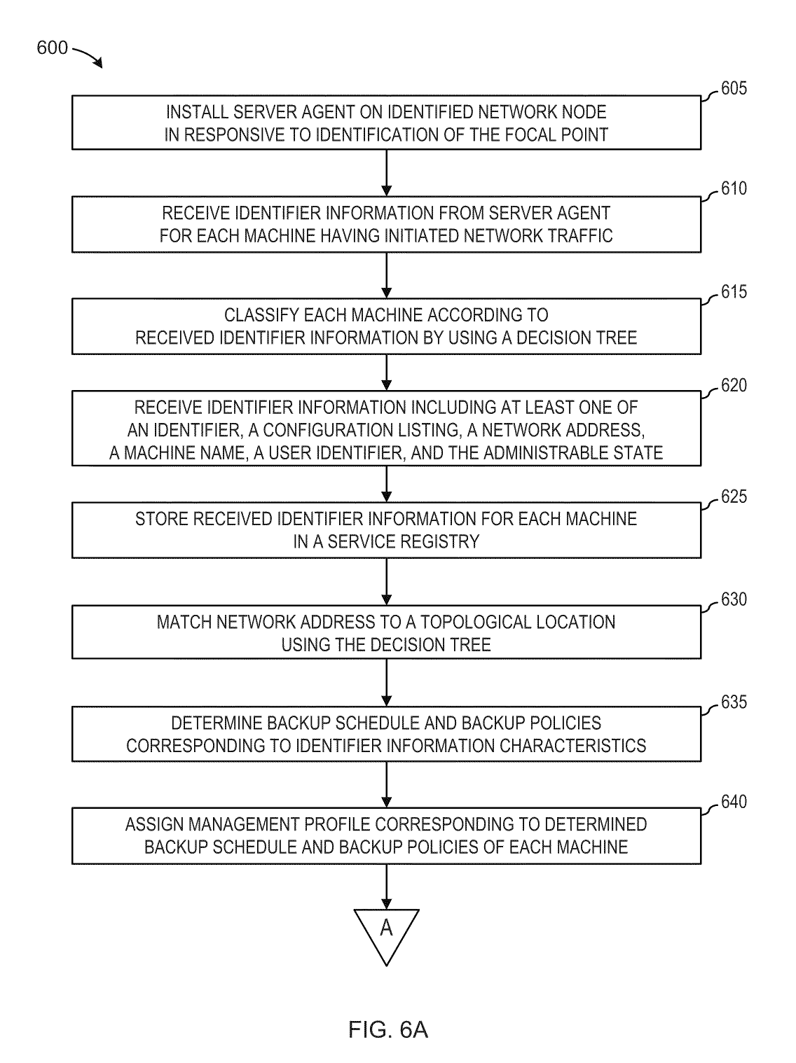

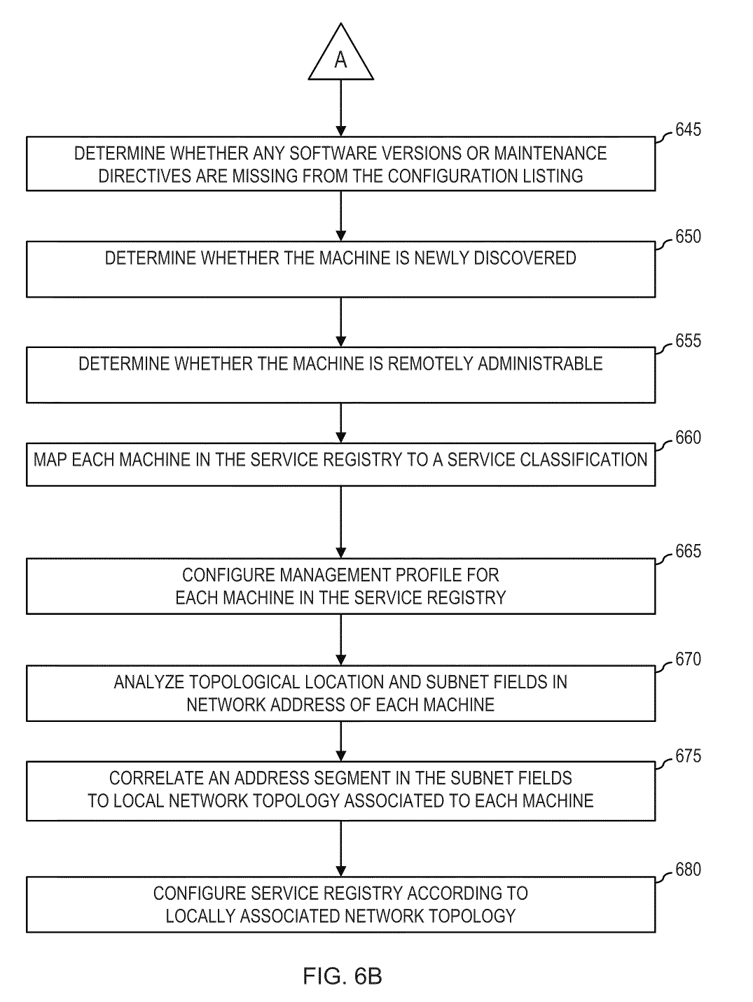

FIGS. 6A and 6B depict an example method of configuring a service registry to support software and data provisioning 600. The method commences with installing 605 a server agent on an identified network node responsible for having been identified as a focal point of network traffic and receiving 610 identifier information from the server agent for each machine having initiated network traffic. The method goes on to classify 615 each machine according to the received identifier information by using a decision tree and receiving 620 identifier information including at least one of an identifier, a configuration listing, a network address, a machine name, a user identifier, and the administrable state. A method continues with storing 625 received identifier information for each machine in a service registry and matching 630 network addresses to a topological location using the decision tree. Next, the method determines 635 backup scheduling and backup policies corresponding to characteristics of the identifier information.

The example method of configuring a service registry continues by determining 645 whether any software versions or maintenance directives are missing from the configuration listing and determining 650 whether the machine is newly discovered. The method continues with determining 655 whether the machine is remotely administrable and by mapping 660 each machine in the service registry to a service classification. The method also includes configuring 665 a management profile for each machine in the service registry and analyzing 670 the topological location and subject fields in the network address of each machine. The method concludes with correlating 675 an address segment in the subnet fields to the local network topology associated with each machine and configuring 680 the service registry according to be locally associated network topology. Configuring 680 the service registry according to the locally associated network topology may include the assigning of a management profile, service classification, and scheduling of backups and service as described above.

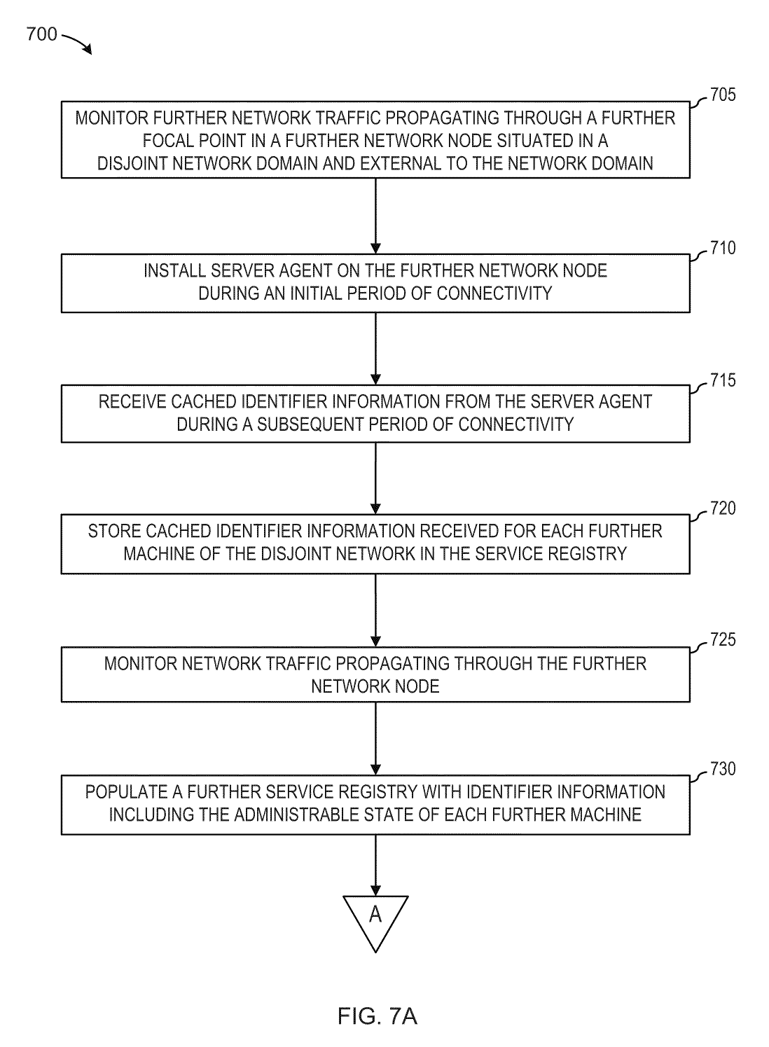

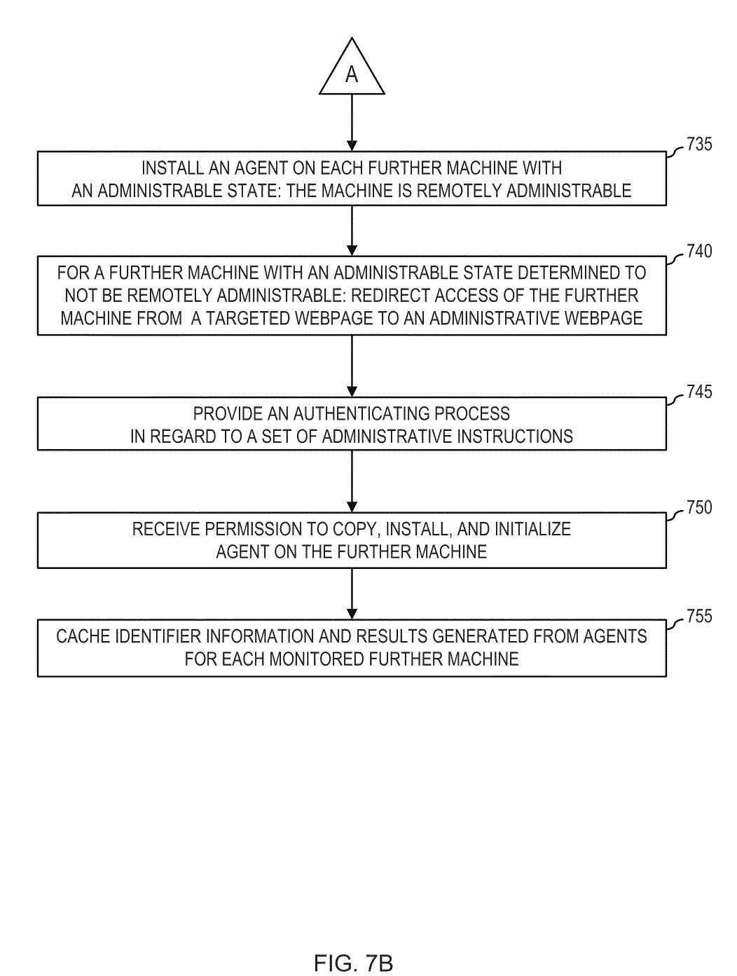

FIGS. 7A and 7B depict an example method of provisioning software and data in a disjoint network domain 700. The method commences with monitoring 705 further network traffic propagating through a further focal point in a further network node situated in a disjoint domain 135 which is external to an initial network domain and installing 710 a server agent on a further network node during an initial period of connectivity by a central server with the further network node. The method proceeds with receiving 715 cached identifier information from the server agent during a subsequent period of connectivity and storing 720 cached identifier information received for each further machine in the disjoint network in the service directory. The method goes on with monitoring 725 the network traffic propagating through the further network node and populating 730 a further service registry with identifier information including the administrable state of each further machine. The method continues with installing 735 an agent on each further machine having an administrable state indicating that the machine is remotely administrable and for a further machine with administrable state indicating that the machine is not remotely administrable proceeding with: redirecting 740 access of the further machine from a targeted webpage to an administrative webpage and providing 745 an authenticating process in regard to a set of administrative instructions. The method concludes with receiving 750 permission to copy, install, and initialize the agent on the further machine and caching 755 identifier information and results generated from the agents for each monitored further machine.

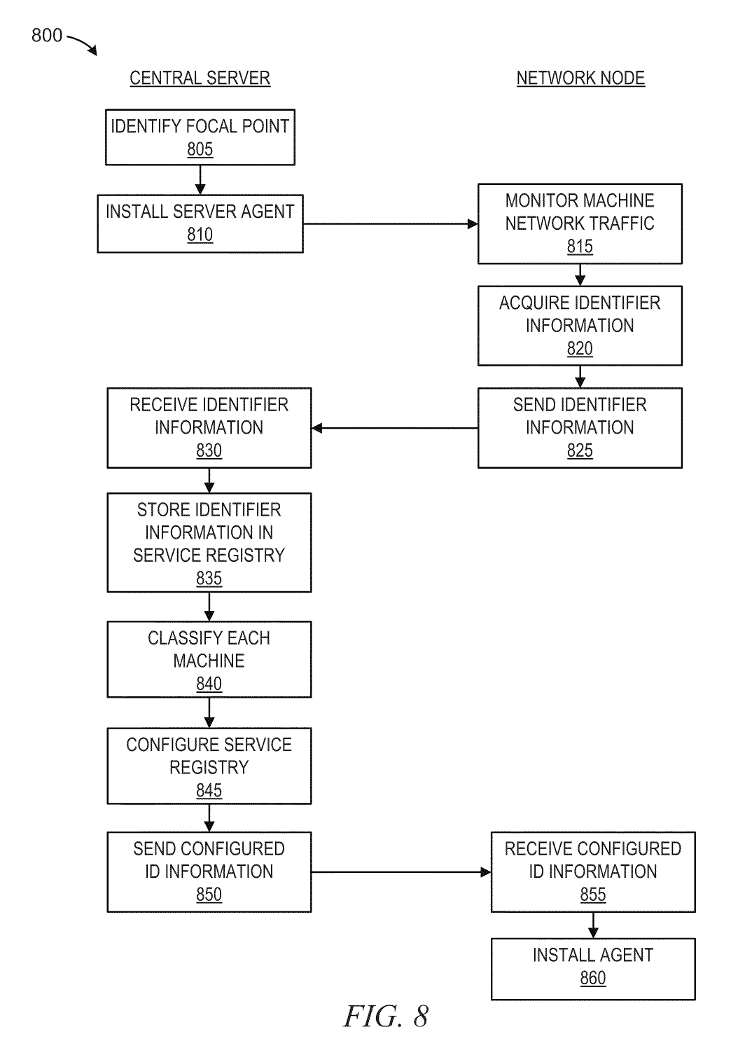

FIG. 8 is an example method of identifying and classifying client machines in a local network domain 800. The method commences with the central server 105 identifying 805 a focal point of network traffic through a network node and installing 810 a server agent on the network node. The method continues with the network node monitoring 815 machine network traffic due to client machines, acquiring 820 identifier information for each machine, and sending 825 the identifier information to the central server 105. The method continues with the central server 105 receiving 830 the identifier information. The central server 105 continues with storing 835 the identifier information in the service registry and classifying 840 each client machine. The central server 105 continues by configuring 845 the service registry and sending 850 configured identifier information to the network node. The network node completes the method by receiving 855 the configured identifier information from a central server 105 and installing 860 an agent on each monitored machine.

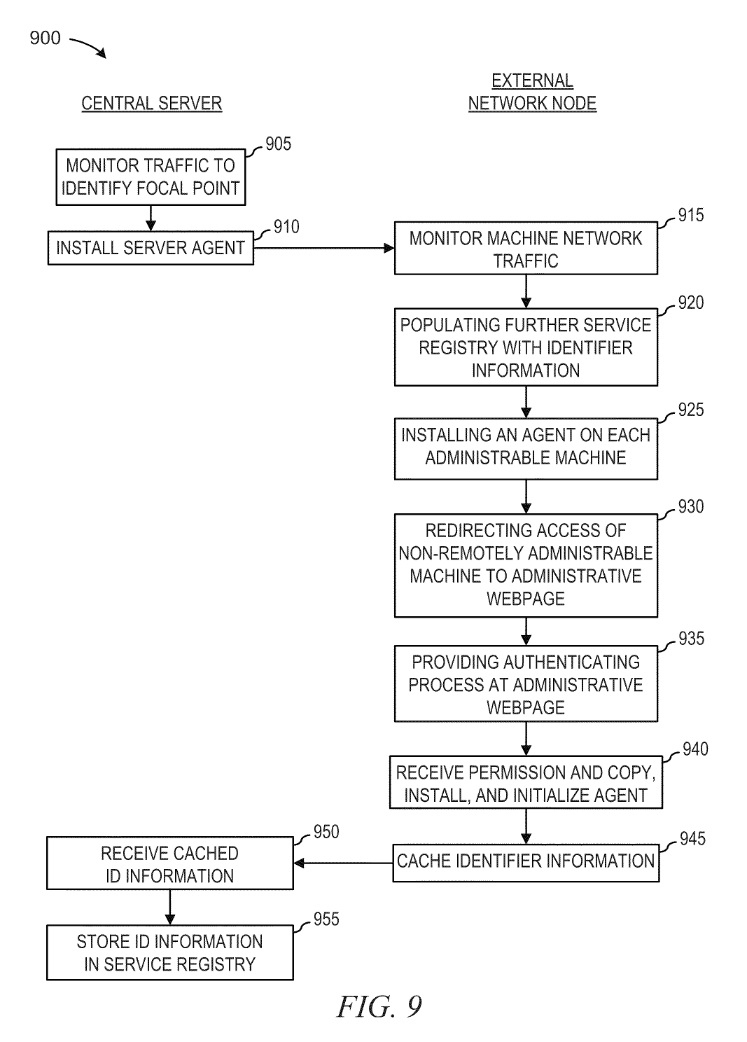

FIG. 9 is an example method of identifying and classifying client machines in a disjoint network domain 900. The method commences with a central server 105 monitoring further network traffic through a remote network node (or equivalently “further network node” or “external network node”) due to further machines within the disjoint network domain and installing 910 a server agent on the remote network node during an initial period of connectivity. The method continues with the remote network node monitoring 915 network traffic, corresponding to the remote machines, propagating through the further network node and populating 920 a further service registry with identifier information, including the administrable state, corresponding to each monitored remote machine. The method continues with the remote network node installing 925 an agent on each further machine having an administrable state indicating the further machine is remotely administrable and for an additional further machine with an administrable state determined to not be remotely administrable, redirecting 930 access of the additional further machine from a targeted webpage to an administrative webpage. The method continues with instructions to the further network node for providing 935 an authenticating process (addressed to a user) regarding a set of administrative instructions at the administrative webpage and responsive to providing the authenticated set of administrative instructions and receiving a user's permission, copying 940, installing, and initializing an agent on the further machine. The instructions to the external network node conclude with caching 945 identifier information and results generated by respective agents for each monitored further machine. The method continues with the central server receiving 950 the cached identifier information from the server agent during a subsequent period of connectivity and storing 955 the cached identifier information received for each further machine of the disjoint network domain in the service registry.

### Modules, Components and Logic

Certain embodiments are described herein as including logic or a number of components, modules, or mechanisms. Modules may constitute either software modules (e.g., code embodied on a non-transitory machine-readable medium) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

For example, any of the modules described herein, such as the classification module, the mapping module, the authentication module, or the network traffic monitor may be implemented as either hardware or software modules. Where a module is configurable, for instance, in the case of network traffic monitor where a focal point of network traffic is identified through a network node, the module may be readily configured in software by the change of programming instructions or the implementation of conditional statements. The network traffic monitor may be configured in a hardware implementation by the programming of a FPGA (see below) or as an application-specific standard product (ASSP), which may have “onboard” (i.e., on-chip) memory for the electrical configuration of programmable hardware to effect configurations for the monitoring of network traffic, for example, which may include an ability to be configured for particular Internet protocol interfaces.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture

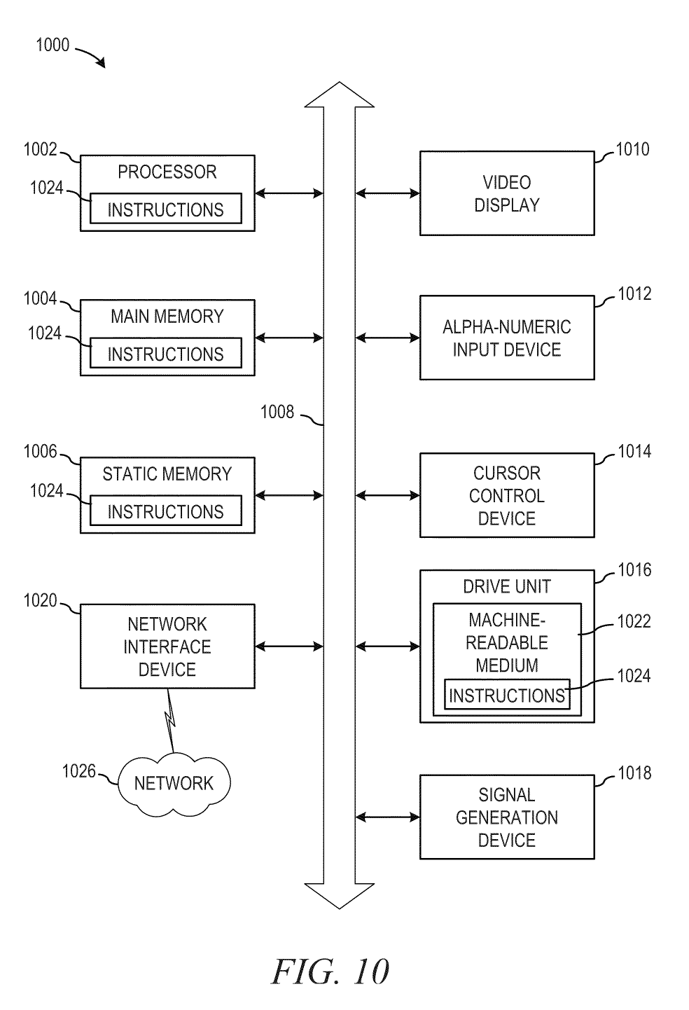

FIG. 10 is a block diagram of machine in the example form of a computer system 1000 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation device 1014 (e.g., a mouse), a disk drive unit 1016, a signal generation device 1018 (e.g., a speaker) and a network interface device 1020.

### Machine-Readable Medium

The disk drive unit 1016 includes a machine-readable medium 1022 on which is stored one or more sets of instructions and data structures (e.g., software) 1024 embodying or utilized by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media.

While the machine-readable medium 1022 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method of provisioning software and data from a central server, the method comprising:
identifying a network node operative as a focal point of network traffic associated with machines in a network domain;
monitoring network traffic propagating through the identified network node;
responsive to monitoring the network traffic, identifying each machine having initiated a corresponding portion of the network traffic through the network node to a network resource;
determining an administrable state of each identified machine; and
provisioning software and data on each identified machine according to the respective determined administrable state.

2. The method of claim 1, further comprising:
responsive to the monitoring of network traffic, populating a service registry with identifier information including the administrable state corresponding to each machine; and
installing an agent on each machine with identifier information having an administrable state indicating that the machine is remotely administrable.

3. The method of claim 1, further comprising:
for a further machine with an administrable state determined to not be remotely administrable, redirecting access of the further machine from a targeted webpage to an administrative webpage;
at the administrative webpage, providing an authenticating process regarding a set of administrative instructions; and
responsive to providing the authenticated set of administrative instructions, receiving permission to copy, install, and initialize an agent on the further machine.

4. The method of claim 1, further comprising:
responsive to identification of the focal point, installing a server agent on the identified network node;
receiving, from the server agent and for each machine having initiated network traffic, identifier information;
classifying, using a decision tree, each machine according to the received identifier information; and
storing the received identifier information for each machine in a service registry,
wherein monitoring network traffic includes receiving identifier information comprising at least one of an identifier, a configuration listing, a network address, a machine name, a user identifier, and the administrable state.

5. The method of claim 4, wherein the decision tree includes matching the network address to a topological location, determining a provisioning schedule and provisioning policies corresponding to characteristics of the identifier information, and assigning a management profile corresponding to the determined provisioning schedule and provisioning policies of each respective machine.

6. The method of claim 4, further comprising:
determining for each respective machine, whether i) any software versions or maintenance directives are missing from the configuration listing, ii) the machine is newly discovered, or iii) the machine is remotely administrable;
mapping each machine within the service registry to a service classification; and
as a result of the classifying, the mapping, and the determination of any missing software versions and maintenance directives, configuring a management profile for each respective machine in the service registry.

7. The method of claim 4, wherein the network address of each machine includes subnet fields and further comprising:
analyzing a topological location and the subnet fields in the network address of each machine;
responsive to analyzing the subnet fields, correlating an address segment in the subnet fields to a local network topology associated to each machine; and
configuring the service registry according to the locally associated network topology.

8. The method of claim 1, further comprising:
monitoring, with the central server, further network traffic propagating through a further focal point associated with a further network node situated within a disjoint network domain external to the network domain, the further network traffic associated with further machines within the disjoint network domain having initiated the further network traffic to a further network resource;
installing a server agent on the further network node during an initial period of connectivity;
receiving cached identifier information from the server agent during a subsequent period of connectivity, the identifier information corresponding to each further machine of the disjoint network domain having accessed the further network resource; and
storing the cached identifier information received for each further machine of the disjoint network domain in the service registry.

9. The method of claim 8, further comprising:
instructing the further network node to:
monitor network traffic propagating through the further network node;
populate a further service registry with identifier information including the administrable state corresponding to each further machine;
install an agent on each further machine with identifier information having an administrable state indicating that the machine is remotely administrable; and
cache identifier information and results generated by respective agents for each monitored further machine during a period extending from the initial period of connectivity through the subsequent period of connectivity.

10. The method of claim 8, further comprising:
instructing the further network node to:
monitor network traffic propagating through the further network node;
populate a further service registry with identifier information including the administrable state corresponding to each further machine;
for a further machine with an administrable state determined to not be remotely administrable:
redirecting access of the further machine from a targeted webpage to an administrative webpage,
at the administrative webpage, providing an authenticating process regarding a set of administrative instructions, and
responsive to providing the authenticated set of administrative instructions and receiving a user's permission, copying, installing, and initializing an agent on the further machine; and
cache identifier information and results generated by respective agents for each monitored further machine during a period extending from the initial period of connectivity through the subsequent period of connectivity.

11. A computer-readable storage medium embodying a set of instructions, that when executed by at least one processor, cause the at least one processor to perform operations comprising:
identifying a network node operative as a focal point of network traffic associated with machines in a network domain;
monitoring network traffic propagating through the identified network node;
responsive to monitoring the network traffic, identifying each machine having initiated a corresponding portion of the network traffic through the network node to a network resource;
determining an administrable state of each identified machine; and
provisioning software and data on each identified machine according to the respective determined administrable state.

12. The computer-readable storage medium of claim 11, wherein the operations further comprise:
responsive to the monitoring of network traffic, populating a service registry with identifier information including the administrable state corresponding to each machine; and
installing an agent on each machine with identifier information having an administrable state indicating that the machine is remotely administrable.

13. The computer-readable storage medium of claim 11, wherein the operations further comprise:
for a further machine with an administrable state determined to not be remotely administrable, redirecting access of the further machine from a targeted webpage to an administrative webpage;
at the administrative webpage, providing an authenticating process regarding a set of administrative instructions; and
responsive to providing the authenticated set of administrative instructions, receiving permission to copy, install, and initialize an agent on the further machine.

14. The computer-readable storage medium of claim 11, wherein the operations further comprise:
responsive to identification of the focal point, installing a server agent on the identified network node;
receiving, from the server agent and for each machine having initiated network traffic, identifier information;
classifying, using a decision tree, each machine according to the received identifier information; and
storing the received identifier information for each machine in a service registry,
wherein monitoring network traffic includes receiving identifier information comprising at least one of an identifier, a configuration listing, a network address, a machine name, a user identifier, and the administrable state.

15. The computer-readable storage medium of claim 14, wherein the decision tree includes matching the network address to a topological location, determining a provisioning schedule and provisioning policies corresponding to characteristics of the identifier information, and assigning a management profile corresponding to the determined provisioning schedule and provisioning policies of each respective machine.

16. The computer-readable storage medium of claim 14, wherein the operations further comprise:
determining for each respective machine, whether i) any software versions or maintenance directives are missing from the configuration listing, ii) the machine is newly discovered, or iii) the machine is remotely administrable;
mapping each machine within the service registry to a service classification; and
as a result of the classifying, the mapping, and the determination of any missing software versions and maintenance directives, configuring a management profile for each respective machine in the service registry.

17. The computer-readable storage medium of claim 14, wherein the operations further comprise:
analyzing a topological location and the subnet fields in the network address of each machine;
responsive to analyzing the subnet fields, correlating an address segment in the subnet fields to a local network topology associated to each machine; and
configuring the service registry according to the locally associated network topology.

18. The computer-readable storage medium of claim 11, wherein the operations further comprise:
monitoring, with the central server, further network traffic propagating through a further focal point associated with a further network node situated within a disjoint network domain external to the network domain, the further network traffic associated with further machines within the disjoint network domain having initiated the further network traffic to a further network resource;
installing a server agent on the further network node during an initial period of connectivity;
receiving cached identifier information from the server agent during a subsequent period of connectivity, the identifier information corresponding to each further machine of the disjoint network domain having accessed the further network resource; and
storing the cached identifier information received for each further machine of the disjoint network domain in the service registry.

19. The computer-readable storage medium of claim 18, wherein the operations further comprise:
instructing the further network node to:
monitor network traffic propagating through the further network node;
populate a further service registry with identifier information including the administrable state corresponding to each further machine;
install an agent on each further machine with identifier information having an administrable state indicating that the machine is remotely administrable;
for an additional further machine with an administrable state determined to not be remotely administrable:
redirecting access of the additional further machine from a targeted webpage to an administrative webpage,
at the administrative webpage, providing an authenticating process regarding a set of administrative instructions, and
responsive to providing the authenticated set of administrative instructions and receiving a user's permission, copying, installing, and initializing an agent on the further machine; and
cache identifier information and results generated by respective agents for each monitored further machine during a period extending from the initial period of connectivity through the subsequent period of connectivity.

20. A system comprising:
a central server communicatively coupled with a plurality of client machines and configured to provide an agent to each of the plurality of client machines;
a network traffic monitor configured to identify a focal point of network traffic through a network node in an associated network domain;
a classification module configured to determine a classification of each of the client machines according to a decision tree and a respective administrable state of each respective client machine;
a mapping module configured to analyze a plurality of address segments in subnet fields of network addresses corresponding to each respective client machines;
an authentication module configured to interactively authenticate administrative instructions with each respective client machine; and
a storage module configured to retain a service registry containing identifier information corresponding to each respective client machine.
